(19) United States
(12) Patent Application Publication
(10) Pub. No.: US 2006/0080495 A1
(43) Pub. Date: Apr. 13, 2006

(54) Method and device for transmitting data on a data line between a central control unit and at least one data processing unit interface of at least one decentralized data processing unit

(75) Inventors: Telmo Glaser, Regensburg (DE); Marten Swart, Obertraubling (DE)

Correspondence Address: LERNER GREENBERG STEMER LLP, P O BOX 2480, HOLLYWOOD, FL, 33022-2480, US

(73) Assignee: Siemens AG

(21) Appl. No.: 11/273,147

(22) Filed: Nov. 14, 2005

Related U.S. Application Data
(63) Continuation of application No. PCT/EP04/50554, filed on Apr. 16, 2004.

(30) Foreign Application Priority Data
May 14, 2003 (DE) 10 321 678.2

(51) Int. Cl. G06F 3/06

(52) U.S. Cl. 711/4

(57) ABSTRACT

A method, and a system suitable for carrying out the method, transmit data on a data line between a central control unit and at least one data processing unit interface of at least one decentralized data processing unit. During the transmission, in order to request data packets, the central control unit periodically outputs synchronization pulses over the data line to the data processing unit interface, whereupon the decentralized data processing unit transmits data packets to the central control unit. According to the invention, the decentralized data processing unit generates, after the synchronization pulse but before the transmission of a first data packet, an electrical discharge pulse, whereby counteracting an electrical charging of the data processing unit interface by the synchronization pulse.

### BACKGROUND OF THE INVENTION

### Field of the Invention

The present invention relates to a method for transmitting data on a data line between a central control unit and at least one data processing unit interface of at least one decentralized data processing unit. In addition, in order to request data packets, the central control unit periodically outputs synchronization pulses over the data line to the data processing unit interface, whereupon the decentralized data processing unit transmits its data available for transmission as at least one data packet via the data processing unit interface to the central control unit.

A method of this type and suitable devices are known, for example, from published German patent application DE 196 09 290 A1, which is herewith incorporated by reference as background disclosure. There, a sensor module is described which is linked to a central control unit over a data line. The sensor module comprises an acceleration-sensitive sensor and periodically transmits an encoded data packet, which is obtained from the sensor measured values of the sensor, every 500 μs to the control unit with the aid of modulated current pulses as soon as it has detected a synchronization voltage pulse on the line (specific reference is had, for instance, to column 1, line 66, to column 2, line 30, or column 4, lines 55 to 62).

FIG. 3 of the prior disclosure shows the most important components of the sensor module (11), the acceleration-sensitive sensor (30) and elements for transmitting the sensor measured values and for receiving the synchronization pulse of the central control unit (5). These elements are generally summarized as the interface of the sensor module or are referred to in short as the sensor interface. As FIG. 3 shows, the individual elements of the sensor interface are in this case energy storage means, for the instance filter means 31 or the capacitor C. In a technical implementation of a sensor module (11) according to FIG. 3, further energy storage means of this type are moreover mostly available in a sensor interface.

The energy storage means of a sensor interface of that type are electrically charged by way of a synchronization pulse, a voltage pulse for instance. If data is/are to be transmitted by means of modulated current pulses in the same way over the same sensor interface as in the present case for instance, the charged energy storage means can affect the signal to be transmitted. By way of example, a desired current increase can not be achieved in this way, which can thereby result in faults in the data transmission to the receiving central control unit. If the central control unit recognizes this transmission fault, the central control unit can possibly decide not to release an occupant protection means until later, for safety reasons, as soon as securely-recognized sensor values are available again. If the central control unit fails to recognize this fault, an occupant protection means can be released unnecessarily, in the worst instance, which in some instances can cause personal injury.

Nevertheless, the problem described does not occur solely with a transmission of data in the field of occupant protection in motor vehicles, but occurs generally with each type of data transmission on a data line between a central control unit and a decentralized, i.e. locally remotely arranged, data processing unit over a data transmission unit interface.

### SUMMARY OF THE INVENTION

It is accordingly an object of the invention to provide a method for transmitting data on a data line between a central control unit and one or more data processing unit interfaces of one or more decentralized data processing units which overcomes the above-mentioned disadvantages of the heretofore-known devices and methods of this general type and which provides for a possibility to transmit data on a data line between a central control unit and a decentralized data processing unit, with an electrical charging of the interface required for communication being counteracted by a data-requesting synchronization pulse.

With the foregoing and other objects in view there is provided, in accordance with the invention, a method of transmitting data on a data line between a central control unit and at least one data processing unit interface of at least one decentralized data processing unit, the method which comprises:

requesting data packets with the central control unit by periodically outputting synchronization pulses over the data line to the data processing unit interface;

after the synchronization pulse, transmitting, with the decentralized data processing unit, data available for transmission as at least one data packet, via the data processing interface to the central control unit;

discharging the control unit interface charged electrically by the synchronization pulse with the decentralized data processing unit before the transmission of a first data packet by outputting a discharging pulse.

With the above and other objects in view there is also provided, in accordance with the invention, a decentralized data processing device configured to transmit data according to the above-outlined method. The device comprises:

a data processing unit interface and a control unit connected to said interface;

wherein at least one of said data processing unit interface and said control unit is configured to output a discharging pulse.

With the above and other objects in view there is also provided, in accordance with the invention, a configuration adapted to carry out the method. The configuration comprises:

a decentralized data processing device with a data processing unit interface and a control unit connected to said interface, wherein said data processing unit interface and/or said control unit is configured to output a discharging pulse;

a central control unit;

a data connection connecting said decentralized data processing device and said central control unit; and

means for transmitting data on said data connection between said central control unit and a data processing unit interface of said decentralized data processing unit.

With the method according to the invention for the transmission of data on a data line between a central control unit and a data processing unit interface of a decentralized data processing device, the central control unit requests data packets from the decentralized data processing unit by means of the periodic output of synchronization pulses over the data line. The decentralized data processing unit transmits the requested data over this same data line as one or also a number of data packets after the synchronization pulse over its data processing unit interface to the central control unit. In accordance with the invention the decentralized data processing unit counteracts an electrical charging of at least one energy storage means of its data processing interface by the synchronization pulse such that the decentralized data processing unit generates, after the use of a synchronization pulse at a synchronization start time but before the transmission of a first data packet after a first waiting time, an electrical discharging pulse after a discharging start time.

A preferred application of the method according to the invention is in this case the field of occupant protection in motor vehicles, as was already explained with reference to the German patent application DE 196 09 290 A1, but also very generally particularly in those fields wherein secure data transmission is of vital importance. With an application of the method according to the invention in the field of occupant protection, the central control unit is preferably a centrally arranged central control unit of an occupant protection system, wherein the decentralized data processing unit and its data processing unit interfaces are preferably a decentralized sensor unit and/or its sensor interfaces connected to the central control unit.

As also already mentioned in the introductory text above, the method according to the invention is preferably used if a synchronization pulse is a voltage pulse which possibly electrically charges the data processing unit interfaces excessively, and the data packets are transmitted by means of modulated current pulses, which are possibly very easily influenced by modified charging conditions of the data processing unit interfaces.

The method is particularly advantageously used if at least one capacitor is used within the data processing interface as energy storage means for instance, said capacitor being charged during the synchronization pulse and being discharged during the discharging pulse and the data transmission.

Since even with a current-modulating data processing unit interface all circuit elements are already available to output current pulses for the data transmission, the discharging pulse of the decentralized data processing device is preferably also a current pulse which is generated in the same manner as the current pulse for data transmission.

Furthermore, it is advantageous for a method according to the invention that the discharging pulse ends at a discharging end time, which should however to take place even before the expiry of a waiting time after the synchronization pulse, at the first output of a data packet through the data processing unit interface by means of the decentralized data processing unit. Possible interference to data communication by a double usage of the data processing unit interface is avoided in this manner.

In accordance with an advantageous embodiment of the invention, the data packet is edge-encoded. In a particularly advantageous implementation, the data bits of the transmitted data packets are Manchester-encoded.

By way of example, the following bit pattern is suitable: 7 data bits configured to transmit sensor measured values or sensor characteristic values; 2 start bits; and a parity bit.

Previously only the connection of one decentralized data processing unit over the data line to the central control unit was discussed. It is naturally also possible to connect a number of decentralized data processing units to a data line. This is particularly advantageous in that the cabling outlay is considerably less, in contrast with a so-called point-to-point connection over the individual data lines at each individual decentralized data processing unit. With each individually connected decentralized data processing unit, one of the advantageous embodiments of the inventive method already described is preferably used.

Other features which are considered as characteristic for the invention are set forth in the appended claims.

Although the invention is illustrated and described herein as embodied in method and devices for transmitting data on a data line between a central control unit and at least one data processing unit interface of at least one decentralized data processing unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic plan view of a motor vehicle (1) with two data lines (PDL, PDL′), which in each case link a central control unit (ECU) according to the invention to two sensor units (S1, S2, S1′, S2′) according to the invention;

FIG. 2 is a block diagram showing a central control unit (ECU) which is linked to two sensor units (S1, S2) over both a ground cable (GND) and also over a data line/supply line (PDL);

FIG. 3 is a block circuit diagram of the internal structure of a sensor unit (S1, S2) according to the invention;

FIG. 4 shows a schematic representation of the temporal sequence of first and second data packets (DP) of a first and/or second sensor unit (S1, S2) during the normal operating mode (NM), with the data packets (DP) either being sent after a first waiting time (t_{dly1}) or after a second waiting time (t_{dly2});

FIG. 5 shows a schematic diagram of the current increase (I_{PDL}(S1,S2)) of a sensor unit (S1, S2) for a Manchester-encoded zero data bit and a Manchester-encoded one data bit over time (t); and

FIG. 6 shows a schematic diagram of an inventive, current-encoded data packet over the time (t).

### DESCRIPTION OF THE PREFERRED EMBODIMENTS

Referring now to the figures of the drawing in detail and first, particularly, to FIG. 1 thereof, there is shown a motor vehicle 1 with a configuration S1, PDL, S2, ECU according to the invention for the transmission of data on a data line PDL between a central control unit (ECU) and two sensor units S1 and S2 linked to the common data line PDL. Furthermore, a further data line PDL′ and further sensor units S1′ and S2′ are represented in FIG. 1, which are similarly linked to the central control unit ECU over the data line PDL′.

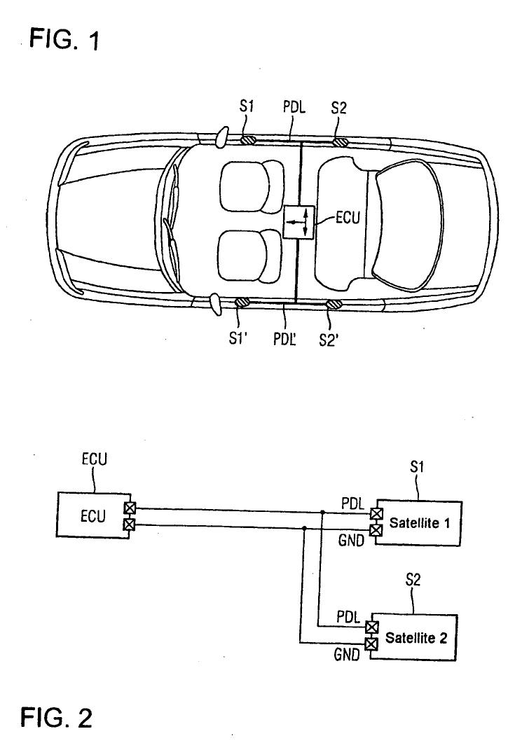

FIG. 2 also shows a central control unit ECU which is linked to a first and a second sensor unit S1 and/or S2 over a common data line PDL.

To this end, the common data line PDL serves on the one hand to periodically, for instance every 500 microseconds (μs), output voltage pulses (Sync) to the sensor units S1 and S2, with the central control unit ECU requesting data packets DP from the sensor units S1, and/or S2. On the other hand, both the first sensor unit S1 and also the second sensor unit S2 on this common data line PDL sends data packets DP in the form of current pulses, which in a test operating mode contain characteristic/test data of the sensor units S1 and/or S2, and during the predominantly normal operation of the two sensor units contain the two sensor measured values.

Also shown is a common ground cable GND which guides the ground potential of the central control unit ECU to all linked satellite units S1, S2.

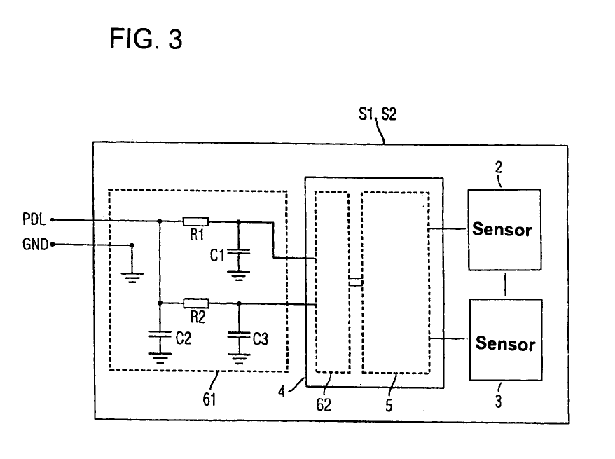

FIG. 3 shows a sensor device S1 and/or S2 according to the invention. The features of the sensor unit S1 and/or S2 are to be described below with reference to a first sensor unit S1. It will be understood that these features also apply to a second sensor unit S2 according to the invention, or any further sensor unit.

The sensor unit S1 has a sensor 2, for example an acceleration sensor 2, consisting of a semiconductor chip comprising a micromechanical semiconductor sensor element and signal-processing semiconductor electronics components which are arranged in an integrated fashion on the same semiconductor chip. A suitable micromechanical sensor element comprises, for instance, by ground structures which can move in one or more sensing directions and are interconnected with static chip parts as capacitance, said ground structures being exposed by etching processes in the manufacturing process of the semiconductor chip. Depending on the direction and strength of an acceleration effect, the ground structures move in different ways which can be measured electrically as a capacitance change. A suitable sensor element is however also a pressure sensor element, wherein a cavity that has been exposed by etching in the semiconductor chip is sealed against the environmental atmospheric pressure by a pressure-tight membrane of remaining semiconductor material. The semiconductor membrane is flexible relative to effects of the external air pressure and can be interconnected with inflexible chip parts as capacitance in a similar manner to the acceleration measuring cells, such that a changing external air pressure can be measured as a changing capacitance of the semiconductor membrane in comparison with the rest of the sensor chip. Similarly, other sensing principles and sensor structures can naturally also be used, for instance mechanical acceleration switches, piezoresistive pressure or acceleration sensors, rotation speed sensors, short-circuit switches or temperature sensors which can detect, for instance, a temperature increase in a cavity which is compressed during an accident, the space inside a motor vehicle door for instance. Thermal acceleration sensors of the MEMSIC company for instance are similarly known (http://www.memsic.com/memsic/), wherein accelerations are detected by means of heated air within the sensor being moved closer to or further from temperature sensors by the action of accelerations, said temperature sensors being able to determine a corresponding temperature change.

FIG. 3 further shows a memory 3 wherein is stored sensor characteristic data, for instance an identification number of the sensor unit S1, its revision level or even calibration data, such as conversion formulae for the measurement range or the like.

FIG. 3 also shows a sensor control unit 4, comprising both a sensor computing unit 5 and a sensor interface 61, 62.

The sensor computing unit 5 can be an application-specific integrated switch, a so-called ASIC 5 (application-specific integrated circuit), but also a microcontroller 5 controlled by way of software.

In the sensor interfaces 61, 62 shown in FIG. 3, a first part 61 of the sensor interface 61, 62 is structured in the form of a discrete electronics circuit comprising resistors R1, R2 and capacitors C1, C2, C3, whereas a second part 62 is integrated within an integrated component of the sensor control unit 4 with the sensor computing unit 5. The complete sensor interfaces 61, 62 can be designed equally as well discretely on a printed circuit board or vice versa within a component in the sensor control unit 4. This incidentally also applies to the sensor 2, which, shown differently, can be similarly as effectively integrated within the sensor control unit 4 on a common chip, and possibly even with all other function units of the sensor unit S1.

A supply voltage is disposed on the data line PDL, which is output by the central control unit ECU. Furthermore, in order to request data packets, the central control unit ECU periodically outputs synchronization pulses Sync over the data line PDF from the sensor unit S1 by means of voltage modulation. These are detected by the sensor interfaces 61, 62 in the line branch.

The sensor unit S1 hereupon transmits data packets DP on the data line PDL, not in the form of voltage pulses however, but in the form of current pulses. To this end, the sensor computing unit 5 detects sensor measured values of the sensor 2, by way of example analogue acceleration measured values, converts the analogue sensor signal into a digital signal and encodes the digital sensor measured value in a resolution which is predetermined for it by both the structure of the sensor and by measuring range settings which are normally stored in the memory 2. Furthermore, the computing unit 5 adds a parity bit PB to the data bits DB generated in this manner, such that it is possible for a receiving unit to detect at least simple bit errors during the data transmission.

The electrical dimensioning of the electrical circuit elements of the first part 61 of the sensor interface 61, 62 represents a compromise between three significant demands on the sensor interface. On the one hand, a desired filter function to smooth the supply voltage of the sensor unit S1 by means of the sensor interfaces 61, 62, must be ensured so that the data communication is not disturbed for instance such that high frequency interference pulses are falsely detected on the data line as synchronization pulses Sync by means of the sensor unit S1. Secondly, the detectability of the high frequency synchronization pulses Sync must nevertheless remain ensured for the sensor unit S1. Finally, the transmission characteristic of the sensor interfaces 61,62 must be suited as best as possible to the desired data communication between the decentralized sensor unit S1 and the central control unit ECU.

In the exemplary embodiment, current-encoded data bits are to be edge-triggered and transmitted with a bit duration of 8 μs. The current increase desired in this case is to lie between 20 to 30 mA above the idle current consumption of the decentralized sensor unit of 5 to 8 mA. A typical synchronization pulse reaches a voltage between 20 to 24 V, whereupon the voltage supply of the decentralized sensor unit without synchronization pulse Sync lies between 6.5 and 12 V. A synchronization pulse lasts between 31 to 33 μs. Advantageous values result for the dimensioning of the resistors R1 and R2 of 47 and 220 Ω for data bits of this type and synchronization pulses of this type, and advantageous capacitance values of 22 nF, 2,2 nF and 1 nF result for the capacitors C1, C2 and C3.

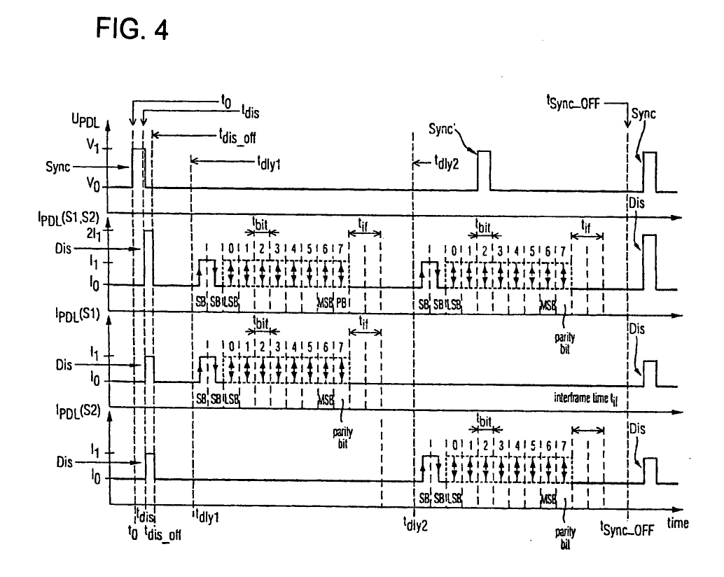

FIG. 4 shows a sequence of two periodical synchronization pulses Sync and a false synchronization pulse Sync′, respectively plotted over the same time axis in the uppermost diagram. In the second diagram the current I_{PDL} (S1, S2) is plotted of higher value, which is generated if two sensor units S1 and S2 are connected to a data line PDL, as already shown in FIG. 2. After a first waiting time t_{dly1} after the use of the synchronization pulse Sync, beginning in each instance with the two start bits SB, the data packet DP of the first sensor unit S1 is output, after a second waiting time t_{dly2} the data packet DP of the second sensor unit S2. The false synchronization pulse Sync′ induced for instance by an electromagnetic interference on the common data line PDL causes both a transmission of a data packet DP from the sensor unit S1 and from the sensor unit S2, as the signal output of both synchronization pulse Sync is blocked at the expiry of an off-time t_{sync}_{_{—}}_{off} following the most recently detected valid synchronization pulse Sync.

To counteract an unintentional charging of the input network R1, C1, R2, C2, C3 of the first part 61 of the sensor interface 61, 62 for instance, which is caused by the synchronization pulse Sync, a short discharging pulse Dis takes place after a discharging off-time t_{dis} by means of both sensor units S1 and S2 with a doubled current amplitude of a data bit DB. The third and the fourth diagram above show the current signal increase I_{PDL} (S1) and I_{PDL} (S2) which is effected by only one sensor unit S1 and/or S2, with the data output of the first sensor unit S1 occurring after the first off-time t_{dly1}, however the data output of the second sensor unit takes place after the second off-time t_{dly2}. Accordingly, in both cases, one discharging pulse Dis alone is sufficient, merely comprising a current amplitude of a data bit DB.

A synchronization start time point t_{DIS} 34 μs after the use of the synchronization pulse Sync and its optimal duration 32 μs is favorable for the times and currents of a data bit DB described above, for the times and currents of a synchronization pulse Sync and the mentioned variables of resistors and capacitances of the first part 61 of the sensor interface 61, 62,

The binary coding of a data packet is described below in further detail:

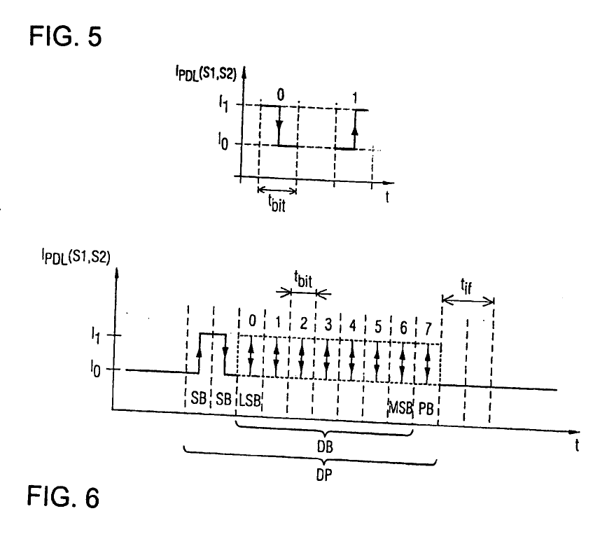

FIG. 5 shows the type of coding of a logical zero status and a logical one status of a data bit of a data packet DP of the sensor unit S1. The current increase I_{PDL} (S1, S2) is represented on the high value axis of the diagram, said current increase being effected by the data bits of a data packet DP. The presently used type of coding of the data bit DB is an edge-coding in the one possible characteristic of a Manchester code. The Manchester code displayed represents a zero bit by a falling edge amongst a bit time t_{Bit} reserved for a bit and vice versa in each case correspondingly a one-bit by an increasing edge of the current signal. To correspondingly represent a sequence of zero bits or a sequence of one bits, at least one clock rate is to be provided for data transmission, the period duration of which amounts to the time duration t_{Bit} of a bit. With a bit duration t_{Bit} of 8 microseconds, a clock rate of at least 125 kHz is required. A multiple of the 125 kHz clock rate is however also possible, for instance the frequently used clock rate within microcontrollers of 8 MHz.

Other edge-encoded data codings are naturally also possible, but also any other binary data codings, the known NRZ (No Return to Zero) coding for instance.

FIG. 6 shows a complete data packet DP in a current/time diagram. The first two bits of a data packet DP are two start bits SB according to a logical sequence 1 0. The subsequent seven data bits from bit 0 to bit 6 represent the binary encoded sensor measured values, with the first transmitted bit being the least significant bit LSB and the last transmitting data bit 6 being the most significant bit MSB. This data structure is identical both in the normal operating mode NM and in the test operating mode TM.

We claim:

1. A method of transmitting data on a data line between a central control unit and at least one data processing unit interface of at least one decentralized data processing unit, the method which comprises:
requesting data packets with the central control unit by periodically outputting synchronization pulses over the data line to the data processing unit interface;
after the synchronization pulse, transmitting, with the decentralized data processing unit, data available for transmission as at least one data packet, via the data processing interface to the central control unit;
discharging the control unit interface charged electrically by the synchronization pulse with the decentralized data processing unit before the transmission of a first data packet by outputting a discharging pulse.

2. The method according to claim 1, wherein the decentralized data processing unit is a sensor unit, the data processing unit interface is a sensor interface, and the method comprises transmitting data packets containing sensor measured values.

3. The method according to claim 1, which comprises outputting the synchronization pulse as a voltage pulse.

4. The method according to claim 1, which comprises transmitting the data packets of the decentralized data processing unit as current pulses.

5. The method according to claim 1, which comprises discharging the control unit interface with a current pulse.

6. The method according to claim 1, wherein the data processing unit interface comprises at least one capacitor, and the method comprises:
electrically charging the capacitor with and during the synchronization pulse; and
discharging the capacitor with and during the discharging pulse.

7. The method according to claim 1, which comprises ending the discharging pulse at a discharging end time (t_{dis}_{_{—}}_{off})/prior to an expiry of a first waiting time (t_{dly1}), from which a first data packet is sent by way of the decentralized data processing unit.

8. The method according to claim 1, which comprises edge-encoding the data bits of the transmitted data packets.

9. The method according to claim 1, which comprises Manchester-encoding the data bits of the transmitted data packets.

10. The method according to claim 1, which comprises defining a data packet with the following bit pattern:
7 data bits configured to transmit sensor measured values or sensor characteristic values;
2 start bits; and
a parity bit.

11. A decentralized data processing device configured to transmit data according to the method of claim 1, the device comprising:
a data processing unit interface and a control unit connected to said interface;
wherein at least one of said data processing unit interface and said control unit is configured to output a discharging pulse.

12. A configuration adapted to carry out the method according to claim 1, comprising:
a decentralized data processing device with a data processing unit interface and a control unit connected to said interface, wherein said data processing unit interface and/or said control unit is configured to output a discharging pulse;
a central control unit;
a data connection connecting said decentralized data processing device and said central control unit; and
means for transmitting data on said data connection between said central control unit and a data processing unit interface of said decentralized data processing unit.
